(19) United States
(12) Patent Application Publication
(10) Pub. No.: US 2026/0249174 A1
(43) Pub. Date: Aug. 27, 2026

(54) ONE OR MORE NON-TRANSITORY COMPUTER-READABLE STORAGE MEDIA, COMPUTER-IMPLEMENTED METHOD, AND INFORMATION PROCESSING SYSTEM

(71) Applicant: Nintendo Co., Ltd., Kyoto (JP)

(72) Inventor: Rei MIYAKE, Kyoto (JP)

(21) Appl. No.: 19/534,203

(22) Filed: Feb. 9, 2026

(30) Foreign Application Priority Data
Feb. 21, 2025 (JP) 2025-026753

(51) Int. Cl. A63F 13/285; A63F 13/525; A63F 13/56; G06F 3/01

(52) U.S. Cl. CPC A63F 13/285; A63F 13/525; A63F 13/56; G06F 3/016

(57) ABSTRACT

An example of an information processing system according to an exemplary embodiment sets a first virtual listener and a first vibration source in a virtual space, attenuates an amplitude of first vibration waveform data corresponding to the first vibration source based on a distance between the first virtual listener and the first vibration source, and attenuates the amplitude so that the further away from a front direction of a virtual camera a direction of the first vibration source relative to the first virtual listener is, the even more attenuated the amplitude is. Then, the information processing system vibrates a vibration device using the first vibration waveform data based on the attenuated amplitude.

### CROSS REFERENCE TO RELATED APPLICATION

This application claims priority to Japanese Patent Application No. 2025-026753 filed on February 21, 2025, the entire contents of which are incorporated herein by reference.

### FIELD

An exemplary embodiment relates to one or more non-transitory computer-readable storage media having stored therein an information processing program, a computer-implemented method, and an information processing system for controlling a vibration device.

### BACKGROUND AND SUMMARY

Conventionally, there is a vibration control program for vibrating a vibration device based on a virtual vibration source in a virtual space.

There is room for improvement in generating a vibration suitable for a predetermined scene in a virtual space.

An exemplary embodiment discloses one or more non-transitory computer-readable storage media having stored therein an information processing program, a computer-implemented method, and an information processing system that are capable of generating a vibration suitable for a predetermined scene.

### First Configuration

A first configuration of the exemplary embodiment is one or more non-transitory computer-readable storage media having stored therein instructions that, when executed, cause one or more processors to perform operations including: regarding first vibration waveform data associated with a first virtual vibration source set in a virtual space and used to vibrate a vibration device, attenuating an amplitude of the first vibration waveform data so that the greater a distance between a first virtual listener and the first virtual vibration source in the virtual space is, the more attenuated the amplitude is, and so that the further away from a front direction of a virtual camera in the virtual space a direction of the first virtual vibration source relative to the first virtual listener is, the even more attenuated the amplitude is, and outputting the first vibration waveform data based on the attenuated amplitude.

Based on the above, the amplitude of first vibration waveform data is attenuated so that the further away from the front direction of a virtual camera a direction from a first virtual vibration source to a first virtual listener is, the more attenuated the amplitude is. Thus, for example, it is possible to vibrate a vibration device by focusing on a vibration source present in the front direction of the virtual camera.

### Second Configuration

According to a second configuration, in the above first configuration, the first virtual listener may be set at a position corresponding to a position of the virtual camera.

Based on the above, based on the position of the first virtual vibration source with respect to a position corresponding to the position of the virtual camera, it is possible to attenuate the amplitude of the first vibration waveform data.

### Third Configuration

According to a third configuration, in the above first or second configuration, the operations may further include decreasing a pitch of the first vibration waveform data so that the further away from the front direction of the virtual camera in the virtual space the direction of the first virtual vibration source relative to the first virtual listener is, the more decreased the pitch is.

Based on the above, it is possible to further decrease the pitch of the first vibration waveform data.

### Fourth Configuration

According to a fourth configuration, in according to any of the above first to third configurations, the operations may further include attenuating an amplitude of a high-frequency component of the first vibration waveform data so that the greater the distance between the first virtual listener and the first virtual vibration source in the virtual space is, the more attenuated the amplitude is, and so that the further away from the front direction of the virtual camera in the virtual space the direction of the first virtual vibration source relative to the first virtual listener is, the more attenuated the amplitude is.

Based on the above, it is possible to attenuate the amplitude of a high-frequency component.

### Fifth Configuration

According to a fifth configuration, in the above second configuration, the operations may further include: controlling a player object in the virtual space based on an operation input; and regarding second vibration waveform data associated with a second virtual vibration source set in the virtual space and used to vibrate the vibration device, attenuating an amplitude of the second vibration waveform data so that the greater a distance between a second virtual listener set at a position corresponding to the player object and the second virtual vibration source is, the more attenuated the amplitude is, and outputting the second vibration waveform data based on the attenuated amplitude.

Based on the above, based on the position of a second virtual vibration source with respect to a position corresponding to the position of a player object, it is possible to attenuate the amplitude of second vibration waveform data.

### Sixth Configuration

According to a sixth configuration, in any of the above first to fifth configurations, the vibration device at least may include a first vibration device and a second vibration device, and the operations may further include: if the distance between the first virtual listener and the first virtual vibration source is further closer than a first reference, making correction to bring a first left/right balance parameter close to a value indicating that a left/right bias is small, the first left/right balance parameter indicating a left/right bias degree according to a slope with respect to the front direction of the virtual camera in the direction of the first virtual vibration source relative to the first virtual listener; and based on the first left/right balance parameter, determining the amplitude of the first vibration waveform data for the first vibration device and the amplitude of the first vibration waveform data for the second vibration device and outputting the amplitudes.

Based on the above, if the distance between the first virtual listener and the first virtual vibration source is smaller than a first reference, it is possible to make correction to bring a first left/right balance parameter close to a value indicating that a left/right bias is small. Consequently, for example, regarding the first virtual vibration source located relatively close, it is possible to vibrate a first vibration device and a second vibration device by focusing more the closeness to the first virtual vibration source than the direction of the first virtual vibration source.

### Seventh Configuration

According to a seventh configuration, in the above sixth configuration, the operations may further include: controlling a player object in the virtual space based on an operation input; and regarding second vibration waveform data associated with a second virtual vibration source set in the virtual space and used to vibrate the vibration device, if a distance between a second virtual listener set at a position corresponding to the player object and a second virtual vibration source is further closer than a second reference, making correction to bring a second left/right balance parameter close to a value indicating that the left/right bias is small, the second left/right balance parameter indicating a left/right bias degree according to a slope with respect to the front direction of the virtual camera in a direction of the second virtual vibration source relative to the second virtual listener, and based on the second left/right balance parameter, determining the amplitude of the first vibration waveform data for the first vibration device and the amplitude of the second vibration waveform data for the second vibration device and outputting the amplitudes.

Based on the above, based on the position of a second virtual vibration source with respect to a position corresponding to the position of a player object, it is possible to attenuate the amplitude of second vibration waveform data. If the distance between a second virtual listener and the second virtual vibration source is smaller than a second reference, it is possible to make correction to bring a second left/right balance parameter close to a value indicating that a left/right bias is small. Consequently, for example, regarding the second virtual vibration source located closer than the second reference, it is possible to vibrate a first vibration device and a second vibration device by focusing more on the closeness to the second virtual vibration source than the direction of the second virtual vibration source.

### Eighth Configuration

An eighth configuration is one or more non-transitory computer-readable storage media having stored therein instructions that, when executed, cause one or more processors to perform operations including: controlling a player object in a virtual space based on an operation input; controlling a virtual camera in the virtual space; and regarding first vibration waveform data associated with a first virtual vibration source set in the virtual space and second vibration waveform data associated with a second virtual vibration source set in the virtual space that are used to vibrate a vibration device including a first vibration device and a second vibration device, attenuating an amplitude of the first vibration waveform data so that the greater a distance between a first virtual listener set at a position corresponding to a position of the virtual camera and the first virtual vibration source is, the more attenuated the amplitude is, if the distance between the first virtual listener and the first virtual vibration source is further closer than a first reference, making correction to bring a first left/right balance parameter close to a value indicating that a left/right bias is small, the first left/right balance parameter indicating a left/right bias degree according to a slope with respect to a front direction of the virtual camera in a direction of the first virtual vibration source relative to the first virtual listener, based on the first left/right balance parameter, determining the amplitude of the first vibration waveform data for the first vibration device and the amplitude of the first vibration waveform data for the second vibration device and outputting the amplitudes, attenuating an amplitude of the second vibration waveform data so that the greater a distance between a second virtual listener set at a position corresponding to the player object and the second virtual vibration source is, the more attenuated the amplitude is, if the distance between the second virtual listener and the second virtual vibration source is further closer than a second reference, making correction to bring a second left/right balance parameter close to a value indicating that a left/right bias is small, the second left/right balance parameter indicating a left/right bias degree according to a slope with respect to the front direction of the virtual camera in the a direction of the second virtual vibration source relative to the second virtual listener, and based on the second left/right balance parameter, determining the amplitude of the first vibration waveform data for the first vibration device and the amplitude of the second vibration waveform data for the second vibration device and outputting the amplitudes.

Based on the above, based on the position of a first virtual vibration source with respect to a position corresponding to the position of a virtual camera, it is possible to attenuate the amplitude of first vibration waveform data. Based on the position of a second virtual vibration source with respect to a position corresponding to the position of a player object, it is possible to attenuate the amplitude of second vibration waveform data. If the distance between a first virtual listener and the first virtual vibration source is smaller than a first reference, it is possible to make correction to bring a first left/right balance parameter close to a value indicating that a left/right bias is small. If the distance between a second virtual listener and the second virtual vibration source is smaller than a second reference, it is possible to make correction to bring a second left/right balance parameter close to a value indicating that a left/right bias is small. Consequently, regarding the first virtual vibration source located closer than the first reference and the second virtual vibration source located closer than the second reference, it is possible to vibrate a first vibration device and a second vibration device by focusing more on the closeness to the first virtual vibration source and the second virtual vibration source than the directions of the first virtual vibration source and the second virtual vibration source.

Another configuration may be a computer-implemented method for controlling a vibration of a vibration device, or may be an information processing system.

According to an example of the exemplary embodiment, it is possible to vibrate a vibration device by focusing on a vibration source located in a front direction of a virtual camera.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting block diagram showing examples of the internal configurations of a main body apparatus 2, a left controller 3, and a right controller 4;

FIG. 4 is an example non-limiting diagram of a part of a virtual space during a racing game according to an exemplary embodiment when viewed from above;

FIG. 5 is an example non-limiting diagram showing the relationship between an entire attenuation rate and a distance d;

FIG. 6 is an example non-limiting diagram showing the relationship between a high-frequency band attenuation rate and the distance d;

FIG. 7 is an example non-limiting diagram of a first virtual listener L and a first vibration source S when viewed from above in the virtual space and is an example non-limiting diagram illustrating rear attenuation;

FIG. 8 is an example non-limiting diagram showing an example of the relationship between a rear rate and a rear attenuation rate of an amplitude;

FIG. 9 is an example non-limiting diagram showing an example of the relationship between the rear rate and a rear attenuation rate of a frequency;

FIG. 10 is an example non-limiting diagram illustrating what intensity is used to vibrate a left vibrator 36 and a right vibrator 46 in a case where the first vibration source S is located at any of positions SP1 to SP4 with respect to the first virtual listener L;

FIG. 11A is an example non-limiting diagram of a player object P and a second vibration source T when viewed from above in the virtual space and is an example non-limiting diagram showing an example of the state where the second vibration source T is close to the right side of the player object P;

FIG. 11B is an example non-limiting diagram of the player object P and the second vibration source T when viewed from above in the virtual space and is an example non-limiting diagram showing an example of the state where a part of the right side of the player object P overlaps the second vibration source T;

FIG. 11C is an example non-limiting diagram of the player object P and the second vibration source T when viewed from above in the virtual space and is an example non-limiting diagram showing an example of the state where the entirety of the player object P overlaps the second vibration source T;

FIG. 12 is an example non-limiting diagram showing examples of various pieces of data stored in the game system 1;

FIG. 13 is an example non-limiting flow chart showing an example of game processing regarding the racing game; and

FIG. 14 is an example non-limiting flow chart showing the details of a first vibration control process in step S15.

### DETAILED DESCRIPTION OF NON-LIMITING EXAMPLE EMBODIMENTS

### Game System Configuration

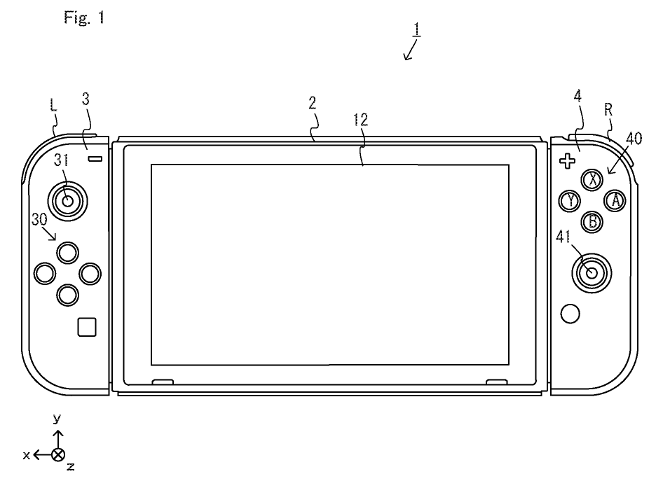

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an up button, a down button, a right button, and a left button, a plurality of buttons 40 (an A-button, a B-button, an X-button, a Y-button, an L-button, an R-button, and the like), a left analog stick 31, and a right analog stick 41 as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a "controller".

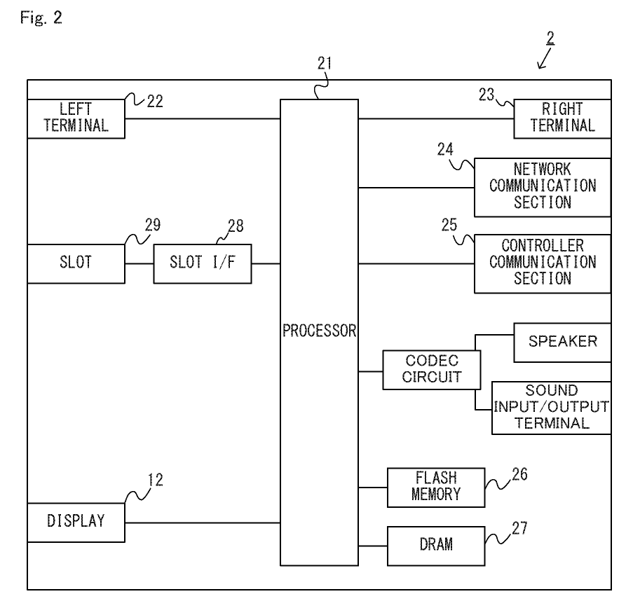

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as "I/F") 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi (registered trademark) standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called "local communication" in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

The main body apparatus 2 also includes a codec circuit, a speaker (specifically, a left speaker and a right speaker), and an audio input/output terminal. The codec circuit is connected to the speaker and the audio input/output terminal and also connected to the processor 21. The codec circuit is a circuit that controls the input and output of audio data to and from the speaker and the audio input/output terminal.

It should be noted that, in addition to the elements shown in FIG. 2, the main body apparatus 2 includes a battery that supplies power and an output terminal for outputting images and audio to an external display device (e.g., a television) separate from the display 12.

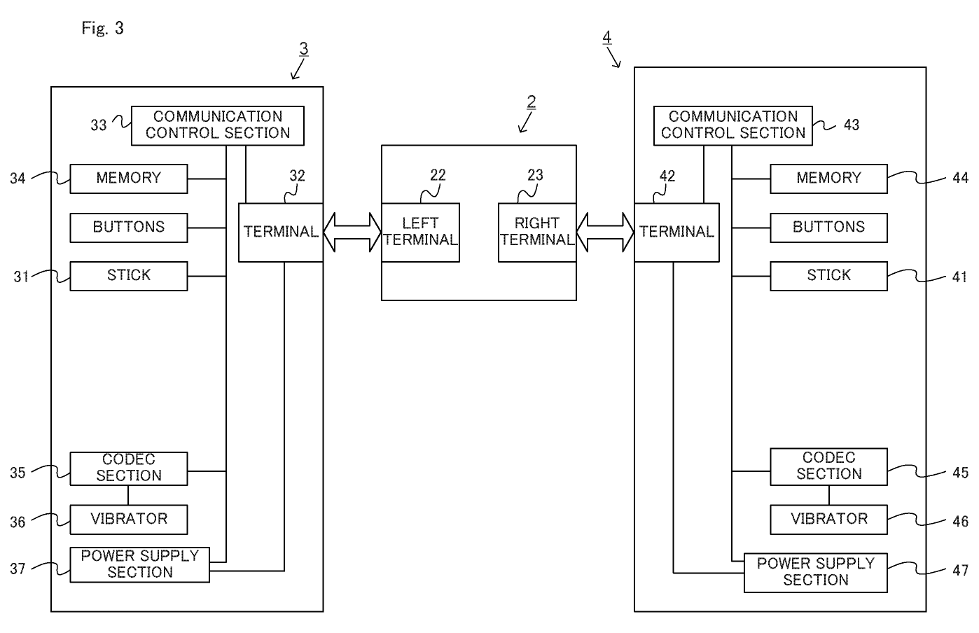

FIG. 3 is a block diagram showing examples of the internal configurations of the main body apparatus 2, the left controller 3, and the right controller 4. It should be noted that the details of the internal configuration of the main body apparatus 2 are shown in FIG. 2 and therefore are omitted in FIG. 3.

The left controller 3 includes a communication control section 33, which communicates with the main body apparatus 2. As shown in FIG. 3, the communication control section 33 is connected to components including a terminal 32. In the exemplary embodiment, the communication control section 33 can communicate with the main body apparatus 2 through both wired communication via the terminal 32 and wireless communication not via the terminal 32. The communication control section 33 controls the method for communication performed by the left controller 3 with the main body apparatus 2. That is, when the left controller 3 is attached to the main body apparatus 2, the communication control section 33 communicates with the main body apparatus 2 via the terminal 32. Further, when the left controller 3 is detached from the main body apparatus 2, the communication control section 33 wirelessly communicates with the main body apparatus 2 (specifically, the controller communication section 25). The wireless communication between the controller communication section 25 and the communication control section 33 is performed in accordance with the Bluetooth (registered trademark) standard, for example.

Further, the left controller 3 includes a memory 34 such as a flash memory. The communication control section 33 includes, for example, a microcomputer (or a microprocessor) and executes firmware stored in the memory 34, thereby performing various processes.

The left controller 3 includes buttons 103 (specifically, the buttons 30, the L-button, and the like). Further, the left controller 3 includes the analog stick 31. Each of the buttons and the analog stick 31 outputs information regarding an operation performed on itself to the communication control section 33 repeatedly at appropriate timing.

The communication control section 33 acquires information regarding an input from each of input sections (specifically, the buttons, the analog stick 31, and the like). The communication control section 33 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 31 based on the operation data.

The left controller 3 includes a vibrator 36 for generating a vibration. In the exemplary embodiment, the vibrator 36 is controlled based on vibration data from the main body apparatus 2. That is, if the communication control section 33 receives the above vibration data from the main body apparatus 2, the communication control section 33 drives the vibrator 36 in accordance with the received command. Here, the left controller 3 includes a codec section 35. If the communication control section 33 receives the above vibration data, the communication control section 33 outputs a control signal corresponding to the vibration data to the codec section 35. The codec section 35 generates a driving signal for driving the vibrator 36 from the control signal from the communication control section 33 and gives the driving signal to the vibrator 36. Consequently, the vibrator 36 operates. The vibration data from the main body apparatus 2 may be transmitted to the controller at predetermined time intervals (e.g., 1/200-second intervals).

Specifically, the vibration data includes the frequency (the number of vibrations per unit time; also referred to as the "pitch") and the amplitude of a vibration. The vibrator 36 is configured to vibrate at the frequency and the amplitude specified based on the vibration data. For example, the vibrator 36 is a linear vibration motor driven in a predetermined direction. The vibrator 36 may be a linear vibration motor configured to vibrate at a first resonance frequency in a first direction and vibrate at a second resonance frequency lower than the first resonance frequency in a second direction. Such a vibrator 36 can vibrate in a first frequency band (a high-frequency band) including the first resonance frequency and also vibrate in a second frequency band (a low-frequency band) including the second resonance frequency.

Vibration data transmitted from the main body apparatus 2 includes first vibration data and second vibration data. The first vibration data includes the frequency and the amplitude in the high-frequency band. The second vibration data includes the frequency and the amplitude in the low-frequency band. The left controller 3 receives the vibration data including the first vibration data and the second vibration data from the main body apparatus 2. The left controller 3 controls the vibrator 36 based on the first vibration data and the second vibration data, whereby the vibrator 36 can vibrate at frequencies from the low-frequency band to the high-frequency band. The main body apparatus 2 transmits vibration data at predetermined time intervals (e.g., 1/200-second intervals) and changes the frequency and the amplitude included in each of the pieces of vibration data and thereby can vibrate the vibrator 36 in various vibration patterns. For example, based on vibration waveform data indicating the waveform of a vibration (data in which frequencies and amplitudes are arranged in chronological order), the main body apparatus 2 can vibrate the vibrator 36 based on the waveform according to the vibration waveform data.

The left controller 3 includes a power supply section 37. In the exemplary embodiment, the power supply section 37 includes a battery and a power control circuit. Although not shown in FIG. 3, the power control circuit is connected to the battery and also connected to components of the left controller 3 (specifically, components that receive power supplied from the battery).

As shown in FIG. 3, the right controller 4 includes a communication control section 43, which communicates with the main body apparatus 2. Further, the right controller 4 includes a memory 44, which is connected to the communication control section 43. The communication control section 43 is connected to components including a terminal 42. The communication control section 43 and the memory 44 have functions similar to those of the communication control section 33 and the memory 34, respectively, of the left controller 3.

Further, the right controller 4 includes a vibrator 46 and a codec section 45. The vibrator 46 and the codec section 45 operate similarly to the vibrator 36 and the codec section 35, respectively, of the left controller 3.

The right controller 4 includes a power supply section 47. The power supply section 47 has a function similar to that of the power supply section 37 of the left controller 3 and operates similarly to the power supply section 37.

### Overview of Game

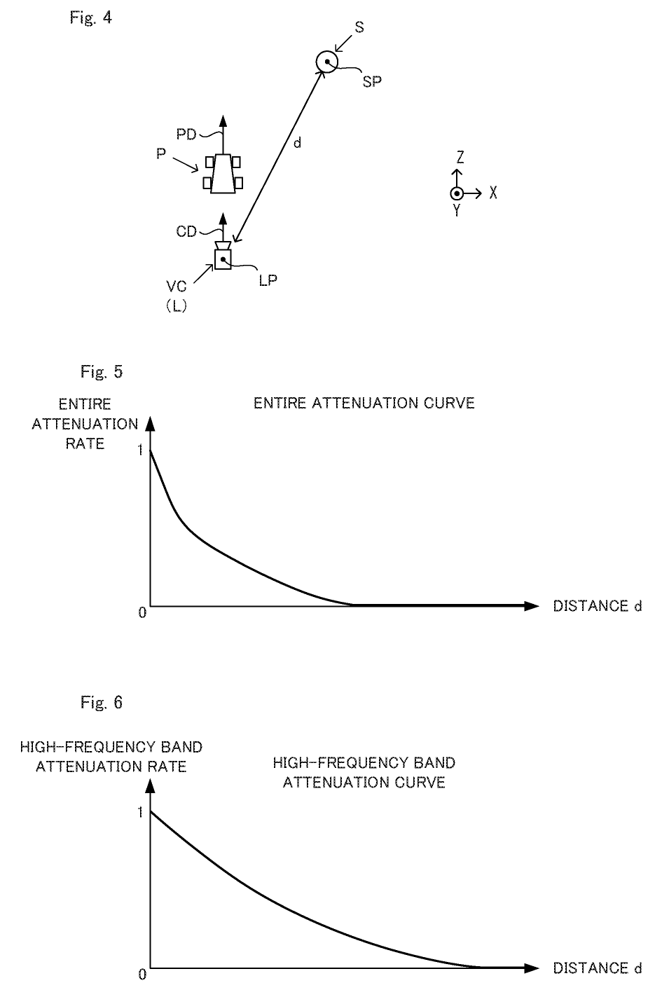

Next, an overview of a game performed by the game system 1 is described. For example, in the exemplary embodiment, a racing game is performed where a player object operated by a player runs on a field in a game space (an example of a virtual space). FIG. 4 is a diagram of a part of the virtual space during the racing game according to the exemplary embodiment when viewed from above.

As shown in FIG. 4, an XYZ orthogonal coordinate system is set in the virtual space. For example, the Y-axis is an axis in an up direction in the virtual space, and the X-axis and the Z-axis are axes perpendicular to the Y-axis.

In the virtual space, a player object P is placed. For example, a direction PD of the player object P is parallel to the Z-axis direction, and the player object P moves in the Z-axis direction. Near the player object P, a virtual camera VC is set. For example, the virtual camera VC is placed at a position a predetermined distance away from the position of the player object P. The virtual camera VC is controlled so that the player object P is present in the direction of a line of sight CD of the virtual camera VC.

In the virtual space, a first vibration source S is set. The first vibration source S is an object that generates a virtual vibration in the virtual space. The first vibration source S may be an object fixed in the virtual space, or may be an object that moves in the virtual space.

The vibrations of the left vibrator 36 and the right vibrator 46 are controlled based on the first vibration source S. In the exemplary embodiment, a plurality of types of first vibration sources S are prepared, and pieces of vibration waveform data according to the types of the first vibration sources S are stored in advance. Vibration waveform data is data indicating the waveform of a vibration and is data indicating in what vibration pattern the vibrator is to be vibrated. Specifically, the vibration waveform data is data in which frequencies and amplitudes at points in time are arranged in chronological order. The vibrators 36 and 46 are vibrated based on the vibration waveform data, whereby the controllers 3 and 4 vibrate in a pattern according to the first vibration source S.

In the virtual space, a first virtual listener L is set. The first virtual listener L is an object used to calculate a virtual vibration based on a first vibration source S and has a position and a direction. For example, a position LP of the first virtual listener L is set to coincide with the position of the virtual camera VC. The front direction of the first virtual listener L coincides with the direction of the line of sight CD of the virtual camera VC. The first virtual listener L is not displayed in a game image.

Based on the positional relationship between the first virtual listener L and a first vibration source S, the attenuation of a vibration based on the first vibration source S is calculated. Regarding the frequency and the amplitude included in the vibration waveform data corresponding to the first vibration source S stored in advance, the main body apparatus 2 calculates the attenuation based on the positional relationship between the first virtual listener L and the first vibration source S. Specifically, the main body apparatus 2 calculates distance attenuation and rear attenuation. Based on the positional relationship between the first virtual listener L and the first vibration source S, the main body apparatus 2 calculates a vibration balance regarding in what balance the left vibrator 36 and the right vibrator 46 are to be vibrated.

On the assumption that each of the first virtual listener L and the first vibration source S is a single point, the positional relationship between the first virtual listener L and the first vibration source S is calculated. For example, the first vibration source S may be set at the center of an object as a vibration source placed in the virtual space. If the object as the vibration source placed in the virtual space is relatively large, the first vibration source S may be set on the surface of the object. In this case, the first vibration source S may be set at the closest point to the first virtual listener L on the surface of the object.

### Distance Attenuation

Next, the distance attenuation is specifically described. The distance attenuation is the process of decreasing the amplitude of a vibration based on a vibration source based on a distance d between the virtual listener and the vibration source. As described above, vibration data transmitted from the main body apparatus 2 to the controllers 3 and 4 includes the first vibration data indicating the frequency and the amplitude in the high-frequency band and the second vibration data indicating the frequency and the amplitude in the low-frequency band. The distance attenuation includes entire attenuation for decreasing the amplitudes in both the high-frequency band and the low-frequency band, and high-frequency band attenuation for decreasing the amplitude in only the high-frequency band.

FIG. 5 is a diagram showing the relationship between an entire attenuation rate and the distance d. FIG. 6 is a diagram showing the relationship between a high-frequency band attenuation rate and the distance d.

The entire attenuation rate is a value indicating the degree to which the amplitudes in both the high-frequency band and the low-frequency band are attenuated, and is a coefficient used to multiply the amplitudes in both the high-frequency band and the low-frequency band. As shown in FIG. 5, for example, the entire attenuation rate is a value that changes from "1" to "0" and decreases in accordance with an increase in the distance d. An entire attenuation curve indicating the change in the entire attenuation rate is a convex downward curve. Specifically, the entire attenuation curve is a curve where the entire attenuation rate decreases by a relatively great amount in accordance with an increase in the distance d in the range where the distance d is small, and the entire attenuation rate decreases by a relatively small amount in accordance with an increase in the distance d in the range where the distance d is great. If the distance d is greater than a first threshold, the entire attenuation rate is "0". In this case, the vibrator is not vibrated. Using the entire attenuation curve shown in FIG. 5, the entire attenuation rate is calculated based on the distance d.

The high-frequency band attenuation rate is a value indicating the degree to which the amplitude in the high-frequency band is attenuated, and is a coefficient used to multiply the amplitude in the high-frequency band. As shown in FIG. 6, for example, the high-frequency band attenuation rate is a value that changes from "1" to "0" and decreases in accordance with an increase in the distance d. A high-frequency band attenuation curve indicating the change in the high-frequency band attenuation rate is a convex downward curve and draws a curve different from the entire attenuation curve shown in FIG. 5. For example, in the high-frequency band attenuation curve, if the distance d is greater than a second threshold (> the first threshold), the high-frequency band attenuation rate is "0". Using the high-frequency band attenuation curve shown in FIG. 6, the high-frequency band attenuation rate is calculated based on the distance d.

The amplitudes in the high-frequency band and the low-frequency band are decreased by multiplying each of the amplitude in the high-frequency band and the amplitude in the low-frequency band by the entire attenuation rate. Further, the amplitude in the high-frequency band is decreased by multiplying the amplitude in the high-frequency band after the entire attenuation by the high-frequency band attenuation rate.

As described above, after the entire attenuation is performed on the amplitudes in the high-frequency band and the low-frequency band, further, the high-frequency band attenuation is performed on the amplitude in the high-frequency band. Consequently, the distance attenuation is performed.

The entire attenuation rate is not limited to the curve shown in FIG. 5, and may be calculated based on a predetermined function where the distance d is a variable. The same applies to the high-frequency band attenuation rate.

### Back Attenuation

Next, the rear attenuation is described. The rear attenuation is the process of decreasing the amplitude and the frequency of a vibration source posterior to a virtual listener.

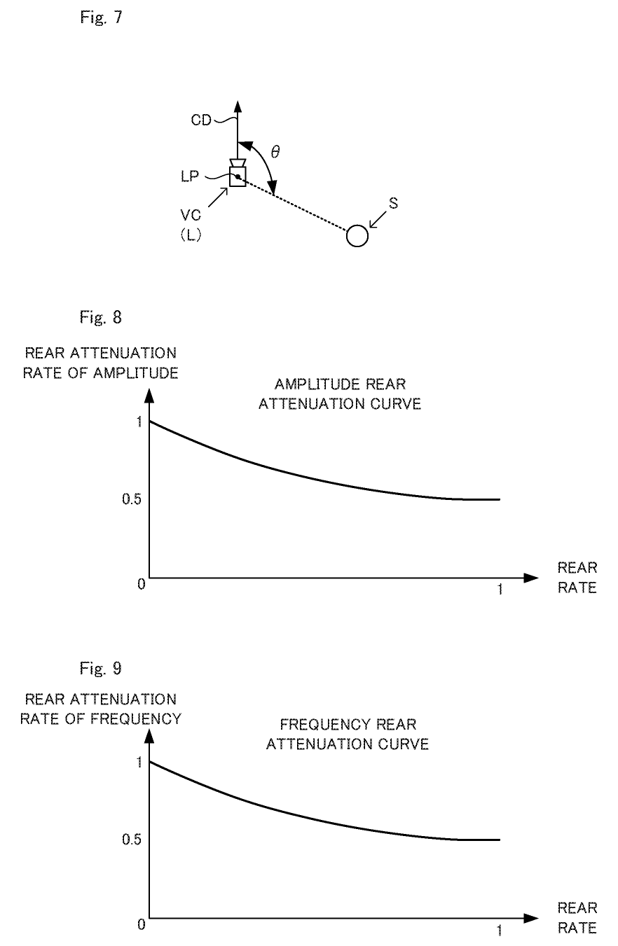

FIG. 7 is a diagram of the first virtual listener L and the first vibration source S when viewed from above in the virtual space and is a diagram illustrating the rear attenuation.

In the exemplary embodiment, a rear rate indicating to what degree the first vibration source S is located posterior to the first virtual listener L is calculated. Specifically, as shown in FIG. 7, an angle θ (degrees) between a direction from the first virtual listener L to the first vibration source S and the front direction (the direction of the line of sight CD) of the virtual camera VC is calculated. The rear rate is a value obtained by dividing the angle θ by 180 degrees and changes in the range from "0" to "1". Based on the calculated rear rate, the amplitudes in the high-frequency band and the low-frequency band decreased by the above distance attenuation are further decreased. Based on the calculated rear rate, the frequencies in the high-frequency band and the low-frequency band are decreased.

FIG. 8 is a diagram showing an example of the relationship between the rear rate and a rear attenuation rate of the amplitude. The rear attenuation rate of the amplitude is a coefficient used to multiply the amplitudes in both the high-frequency band and the low-frequency band. As shown in FIG. 8, for example, the rear attenuation rate of the amplitude changes from "1" to "0.5" in accordance with an increase in the rear rate. For example, if the rear rate is "0" (i.e., if the first vibration source S is located right in front of the first virtual listener L), the rear attenuation rate of the amplitude is "1". In this case, the amplitudes in the high-frequency band and the low-frequency band decreased by the distance attenuation are not further decreased. On the other hand, for example, if the rear rate is "1" (i.e., if the first vibration source S is located right behind the first virtual listener L), the rear attenuation rate of the amplitude is "0.5". In this case, the amplitudes in the high-frequency band and the low-frequency band decreased by the distance attenuation are further decreased to half.

FIG. 9 is a diagram showing an example of the relationship between the rear rate and a rear attenuation rate of the frequency. The rear attenuation rate of the frequency is a coefficient used to multiply the frequencies in both the high-frequency band and the low-frequency band. As shown in FIG. 9, for example, the rear attenuation rate of the frequency changes from "1" to "0.5" in accordance with an increase in the rear rate. For example, if the rear rate is "0", the rear attenuation rate of the frequency is "1". In this case, the frequencies in the high-frequency band and the low-frequency band are not decreased. On the other hand, for example, if the rear rate is "1" (i.e., if the first vibration source S is located right behind the first virtual listener L), the rear attenuation rate of the frequency is "0.5". In this case, the frequencies in the high-frequency band and the low-frequency band included in the vibration waveform data are decreased to half.

An amplitude rear attenuation curve indicating the change in the rear attenuation rate of the amplitude shown in FIG. 8 and a frequency rear attenuation curve indicating the change in the rear attenuation rate of the frequency shown in FIG. 9 are convex downward curves, and the shapes of these curves may be different from or the same as each other.

### Calculation of Vibration Balance

Next, the calculation of the vibration balance is described. Based on the positional relationship between the first vibration source S and the first virtual listener L, the vibration balance is calculated. Specifically, using an amplitude value calculated by the distance attenuation and the rear attenuation, and based on the positional relationship between the first vibration source S and the first virtual listener L, what amplitude value is used to vibrate the left vibrator 36 and the right vibrator 46 is calculated. Here, the amplitude value calculated by the distance attenuation and the rear attenuation is referred to as an "entire amplitude value". It can be said that the calculation of the vibration balance is the calculation of how to distribute the entire amplitude value to the left vibrator 36 and the right vibrator 46.

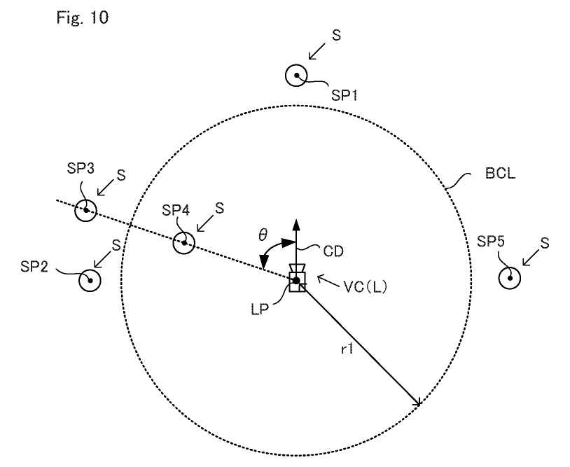

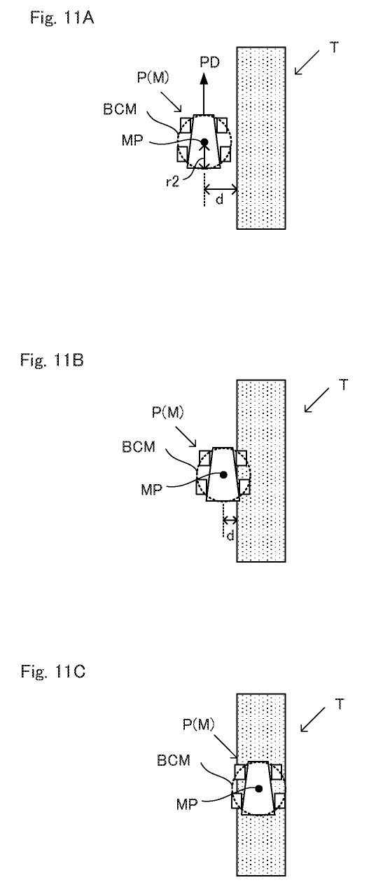

FIG. 10 is a diagram illustrating what intensity is used to vibrate the left vibrator 36 and the right vibrator 46 in a case where the first vibration source S is located at any of positions SP1 to SP5 with respect to the first virtual listener L.

First, a first balance parameter indicating the bias degree of the amplitudes of the left vibrator 36 and the right vibrator 46 is calculated based on the angle θ. The angle θ is the slope in the direction from the position LP of the first virtual listener L to the first vibration source S with respect to the direction of the line of sight CD of the virtual camera. The first balance parameter is data indicating the balance between the intensities of the vibrations of the left vibrator 36 and the right vibrator 46, and for example, may be data indicating the ratio between the amplitudes of the left vibrator 36 and the right vibrator 46. Based on the entire amplitude value calculated by the distance attenuation and the rear attenuation and the first balance parameter, amplitude values of the left vibrator 36 and the right vibrator 46 are determined. The left vibrator 36 and the right vibrator 46 are vibrated at amplitudes according to the first balance parameter, whereby the player can grasp the position of the first vibration source S with respect to the first virtual listener L (the virtual camera VC) based on the vibrations felt by their left and right hands.

For example, as shown in FIG. 10, if the first vibration source S is located at the position SP1 right in front of the first virtual listener L (if θ = 0 degrees), the value of the first balance parameter is set to a "value indicating that the intensities of the vibrations of the left vibrator 36 and the right vibrator 46 are not biased". In this case, the left vibrator 36 and the right vibrator 46 are vibrated based on the same amplitude value. For example, the amplitude values of the left vibrator 36 and the right vibrator 46 may be calculated so that the sum of values obtained by raising the amplitude values of the left vibrator 36 and the right vibrator 46 to the second power matches the entire amplitude value calculated by the distance attenuation and the rear attenuation. For example, in a case where the entire amplitude value is "1", and if the first vibration source S is located at SP1, each of the amplitude values of the left vibrator 36 and the right vibrator 46 may be set to "about 0.71 (the square root of 0.5)". For example, the amplitude values of the left vibrator 36 and the right vibrator 46 may be set so that the sum of the amplitude values of the left vibrator 36 and the right vibrator 46 matches the entire amplitude value.

For example, if the first vibration source S is located at the position SP2 to the exact left of the first virtual listener L (if θ = 90 degrees), the left vibrator 36 is vibrated, and the right vibrator 46 is not vibrated. For example, the amplitude values of the left vibrator 36 and the right vibrator 46 are calculated so that the sum of values obtained by raising the amplitude values of the left vibrator 36 and the right vibrator 46 to the second power matches the entire amplitude value. For example, in a case where the entire amplitude value is "1", and if the first vibration source S is located at the position SP2, the amplitude value of the left vibrator 36 is set to "1", and the amplitude value of the right vibrator 46 is set to "0". For example, in a case where the entire amplitude value is "1", and if the first vibration source S is located at the position SP5 to the exact right of the first virtual listener L, the amplitude value of the left vibrator 36 is set to "0", and the amplitude value of the right vibrator 46 is set to "1".

For example, if the first vibration source S is located at the position SP3 to the diagonally forward left of the first virtual listener L (if θ is an angle slightly smaller than 90 degrees (e.g., 80 degrees)), the left vibrator 36 is vibrated relatively intensely, and the right vibrator 46 is slightly vibrated. For example, if the first vibration source S is located at the position SP3, the ratio between the amplitudes of the left vibrator 36 and the right vibrator 46 may be set of "9:1". For example, if the first vibration source S is located at the position SP3, the amplitude values of the left vibrator 36 and the right vibrator 46 may be set to a ratio of "9:1" so that the sum of the squares of the amplitude values of the left vibrator 36 and the right vibrator 46 is equal to the entire amplitude value.

Here, a first balance correction area BCL is set for the first virtual listener L. For example, the first balance correction area BCL may be a circle (or a sphere) having a radius r1 centered at the first virtual listener L. In a case where the first vibration source S is located inside the first balance correction area BCL, the value of the first balance parameter is corrected to a "value indicating that the bias of the intensities of the vibrations of the left vibrator 36 and the right vibrator 46 is smaller" than in a case where the first vibration source S is located outside the first balance correction area BCL.

For example, a case is assumed where the first vibration source S is located at the position SP4 to the diagonally forward left of the first virtual listener L. The position SP4 is in the same direction as the position SP3 when viewed from the first virtual listener L and is located inside the first balance correction area BCL. In this case, the value of the first balance parameter is corrected to a "value indicating that the bias of the intensities of the vibrations of the left vibrator 36 and the right vibrator 46 is smaller" than in a case where the first vibration source S is located at the position SP3. That is, in a case where the first vibration source S is located at the position SP4, the difference between the amplitude values of the left vibrator 36 and the right vibrator 46 is smaller than in a case where the first vibration source S is located at the position SP3.

For example, if the first vibration source S is located at the position SP3, the ratio between the amplitudes of the left vibrator 36 and the right vibrator 46 is "9:1", whereas, if the first vibration source S is located at the position SP4, the ratio between the amplitudes of the left vibrator 36 and the right vibrator 46 may be corrected from "9:1" to "7:3".

If the first vibration source S is located inside the first balance correction area BCL, the closer to the first virtual listener L the first vibration source S is, the more likely the value of the first balance parameter is to be corrected to the "value indicating that the bias of the intensities of the vibrations of the left vibrator 36 and the right vibrator 46 is smaller". For example, if the first vibration source S is located inside the first balance correction area BCL (if the distance d < r1), the degree of the correction of the first balance parameter differs in accordance with the value of d/r1. For example, if the first vibration source S is located inside the first balance correction area BCL, the smaller the value of d/r1 is, the closer to the "value indicating that the intensities of the vibrations of the left vibrator 36 and the right vibrator 46 are not biased" the value of the first balance parameter is. For example, in a case where the first vibration source S is located inside the first balance correction area BCL, and if the value of d/r1 is a first value, the ratio between the amplitudes of the left vibrator 36 and the right vibrator 46 is corrected from "9:1" to "7:3". In a case where the first vibration source S is located inside the first balance correction area BCL, and if the value of d/r1 is a second value smaller than the first value, the ratio between the amplitudes of the left vibrator 36 and the right vibrator 46 is corrected from "9:1" to "6:4".

As described above, in the exemplary embodiment, if the distance d between the first vibration source S and the first virtual listener L is smaller than the predetermined reference r1, the balance between the amplitudes of the left vibrator 36 and the right vibrator 46 is corrected, thereby decreasing the bias of the intensities of the vibrations of the left vibrator 36 and the right vibrator 46. Consequently, regarding the first vibration source S close to the first virtual listener L, it is possible to cause the player to feel a vibration by giving priority to a distance over a direction.

### Vibration According to Overlap between Player Object P and Second Vibration Source T

Next, a vibration according to overlap between the player object P and a second vibration source T is described. The second vibration source T may be an object that generates a virtual vibration in the virtual space, and may be an object fixed in the virtual space, or may be an object that moves in the virtual space. The second vibration source T is an object having a certain size in the virtual space. For example, the second vibration source T may have a shape such as a sphere, a cylinder, a cuboid, or the like. During the racing game, the player object P occasionally comes into contact with the second vibration source T, or enters the inside of the second vibration source T. For example, the second vibration source T may be a waterfall object placed in the virtual space, or may be an object representing a part of the ground. If the player object P comes into contact with the second vibration source T or enters the inside of the second vibration source T, the left vibrator 36 and the right vibrator 46 vibrate.

FIG. 11A is a diagram of the player object P and the second vibration source T when viewed from above in the virtual space and is a diagram showing an example of the state where the second vibration source T is close to the right side of the player object P. FIG. 11B is a diagram of the player object P and the second vibration source T when viewed from above in the virtual space and is a diagram showing an example of the state where a part of the right side of the player object P overlaps the second vibration source T. FIG. 11C is a diagram of the player object P and the second vibration source T when viewed from above in the virtual space and is a diagram showing an example of the state where the entirety of the player object P overlaps the second vibration source T.

A vibration based on the second vibration source T is controlled based on a second virtual listener M. For example, a position MP of the second virtual listener M is set at the position (e.g., the center) of the player object P. The front direction of the second virtual listener M is set to coincide with the direction PD of the player object P.

Based on a distance d between the second virtual listener M and the second vibration source T, distance attenuation of the second vibration source T is calculated. In the exemplary embodiment, regarding the second vibration source T, the above rear attenuation is not calculated. The position of the second vibration source T used to calculate the distance attenuation may be set at the closest point to the second virtual listener M on the surface of the second vibration source T. In another exemplary embodiment, the position of the second vibration source T used to calculate the distance attenuation may be set at the center of the second vibration source T. In another exemplary embodiment, the above rear attenuation may be calculated based on the positional relationship between the second virtual listener M and the second vibration source T.

Similarly to the first vibration source S, a vibration balance is calculated. Specifically, a second balance parameter indicating the bias degree of the amplitudes of the left vibrator 36 and the right vibrator 46 is calculated based on the positional relationship between the second virtual listener M and the second vibration source T.

More specifically, a second balance correction area BCM is set for the second virtual listener M. For example, the second balance correction area BCM may be a circle (or a sphere) having a radius r2 centered at the second virtual listener M (the player object P). The radius r2 is smaller than the radius r1. For example, the second balance correction area BCM having the radius r2 may have almost the same size as that of the player object P, or may be set to be slightly smaller than the player object P.

As shown in FIG. 11A, the second vibration source T is located near the right side of the player object P. If the player object P and the second vibration source T are close to each other to avoid coming into contact with each other, the second vibration source T is outside the second balance correction area BCM. In this case, the second balance parameter is not corrected, and only the right vibrator 46 between the left vibrator 36 and the right vibrator 46 vibrates. Regarding the second vibration source T, an entire attenuation curve is determined so that the amplitude of the second vibration source T rapidly attenuates in accordance with an increase in the distance d. For example, as shown in FIG. 11A, in the state where the player object P and the second vibration source T are close to each other, the amplitude calculated by the distance attenuation is relatively small, and only the right vibrator 46 vibrates at a relatively small amplitude. If the player object P is located further on the left side than in FIG. 11A, the amplitude is attenuated to "0" by the distance attenuation, and the left vibrator 36 and the right vibrator 46 do not vibrate.

If, on the other hand, as shown in FIG. 11B, a part of the right side of the player object P is in contact with the second vibration source T, the second vibration source T is located inside a second balance correction area BCM. In this case, the second balance parameter is corrected by the above method, and the left vibrator 36 and the right vibrator 46 vibrate. Specifically, the value of the second balance parameter is corrected to the "value indicating that the bias of the intensities of the vibrations of the left vibrator 36 and the right vibrator 46 is smaller", but the value of d/r2 is relatively great, and therefore, the right vibrator 46 vibrates by a greater amount than the left vibrator 36. The distance d between the second virtual listener M and the second vibration source T is smaller than in FIG. 11A, and therefore, the distance attenuation is small. Thus, the right vibrator 46 vibrates by a greater amount than in FIG. 11A, and the left vibrator 36 vibrates by a smaller amount than the right vibrator 46.

As shown in FIG. 11C, if the player object P is located inside the second vibration source T, the distance d between the second virtual listener M and the second vibration source T is "0". In this case, the value of the second balance parameter is corrected to the "value indicating that the intensities of the vibrations of the left vibrator 36 and the right vibrator 46 are not biased". That is, in this case, the left vibrator 36 and the right vibrator 46 are vibrated based on the same amplitude value. The vibration of the second vibration source T is not attenuated by the distance attenuation. Thus, in FIG. 11C, each of the left vibrator 36 and the right vibrator 46 vibrates by a great amount.

As described above, regarding the second vibration source T, the vibration is calculated based on the second virtual listener M. The second virtual listener is set at the position of the player object P. The second balance correction area BCM having almost the same size as that of the player object P is set at the position of the player object P. Consequently, also regarding the second vibration source T, it is possible to calculate the distance attenuation and the vibration balance by a method similar to that for the first vibration source S. If the player object P is in contact with the second vibration source T, it is possible to vibrate the left vibrator 36 and the right vibrator 46 by a great amount. If the second vibration source T is close to either of the left and right with respect to the player object P, it is possible to vibrate either of the left vibrator 36 and the right vibrator 46 by a great amount.

In the exemplary embodiment, the first vibration source S or the second vibration source T is determined in accordance with the type of an object placed in the virtual space. For example, the first vibration source S may be an object that generates a vibration over a relatively wide range in the virtual space. For example, the second vibration source T may be an object that generates a vibration in a relatively narrow range in the virtual space, and may be an object that can come into contact with the player object P.

### Details of Vibration Control Process

Next, the details of game processing including vibration control of the left vibrator 36 and the right vibrator 46 are described.

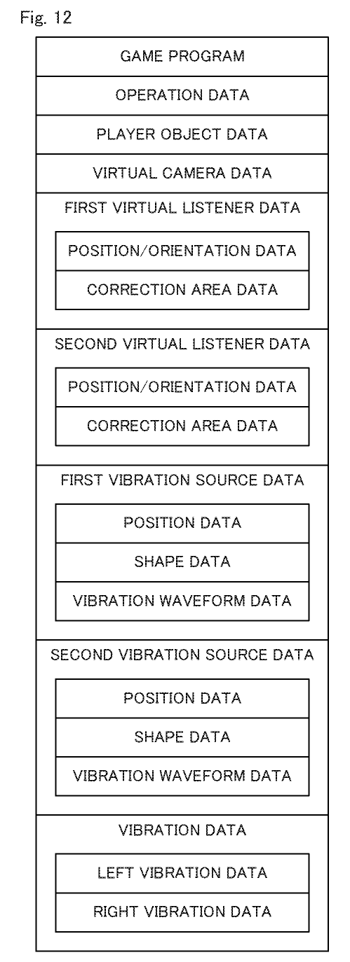

FIG. 12 is a diagram showing examples of various pieces of data stored in the game system 1. As shown in FIG. 12, a memory (e.g., the DRAM 27, the flash memory 26, or a storage medium attached to the slot 29) of the game system 1 stores a game program, operation data, player object data, virtual camera data, first virtual listener data, second virtual listener data, first vibration source data, second vibration source data, and vibration data.

The game program is a program for executing game processing according to the exemplary embodiment. The program includes instructions to calculate the above distance attenuation, rear attenuation, and vibration balance. The game program is stored in advance in the storage medium attached to the slot 29 or the flash memory 26 and is loaded into the DRAM 27 when a game is executed.

For example, the operation data is data according to an operation of the player transmitted from the controllers 3 and 4. The operation data is transmitted from the controllers to the main body apparatus 2 at predetermined time intervals (e.g., 1/200-second intervals).

The player object data is data regarding the player object P controlled by the player. The player object data includes shape data indicating the shape and the external appearance of the player object P, and data indicating the position, the direction, the velocity, the moving direction, and the like in the virtual space of the player object P.

The virtual camera data includes data indicating the position and the direction of the line of sight of the virtual camera VC.

The first virtual listener data is data regarding the first virtual listener L. The first virtual listener data includes position/orientation data indicating the position LP and the direction of the first virtual listener L, and correction area data indicating the first balance correction area BCL having the radius r1 set for the first virtual listener L.

The second virtual listener data is data regarding the second virtual listener M. The second virtual listener data includes position/orientation data indicating the position MP and the direction of the second virtual listener M, and correction area data indicating the second balance correction area BCM having the radius r2 set for the second virtual listener M.

The first vibration source data is data regarding the first vibration source S. In the exemplary embodiment, a plurality of first vibration sources S are set in the virtual space. The first vibration source data includes data regarding each of the plurality of first vibration sources S. The first vibration source data includes position data indicating the position of the first vibration source S, and shape data indicating the shape of the first vibration source S. The first vibration source data also includes vibration waveform data corresponding to the first vibration source S. The vibration waveform data is data in which data indicating frequencies and amplitudes in the high-frequency band and data indicating frequencies and amplitudes in the low-frequency band are stored in chronological order. The vibration waveform data is reproduced, whereby a vibrator vibrates in a vibration pattern according to the first vibration source S.

The second vibration source data is data regarding the second vibration source T. In the exemplary embodiment, a plurality of second vibration sources T are set in the virtual space. The second vibration source data includes data regarding each of the plurality of second vibration sources T. The second vibration source data includes position data indicating the position of the second vibration source T, and shape data indicating the shape of the second vibration source T. The second vibration source data also includes vibration waveform data corresponding to the second vibration source T.

The vibration data includes left vibration data transmitted to the left controller 3 and right vibration data transmitted to the right controller 4. Each of the left vibration data and the right vibration data includes the frequency and the amplitude. The vibration data is transmitted from the main body apparatus 2 to the controllers 3 and 4 at predetermined time intervals (e.g., 1/200-second intervals).

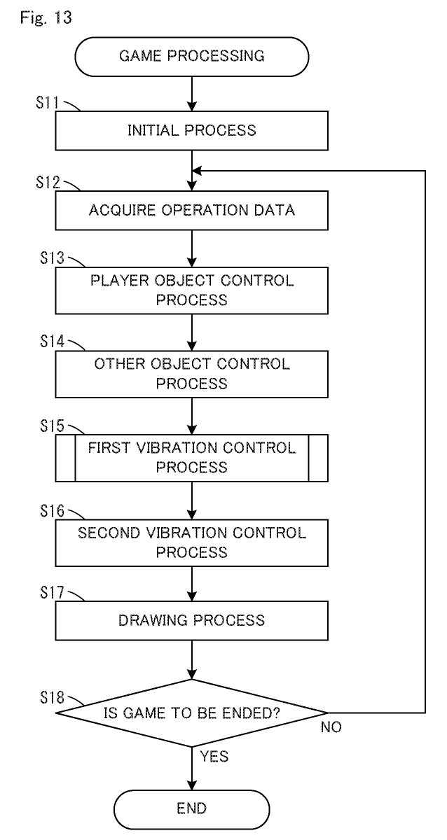

Next, game processing performed by the game system 1 is described. FIG. 13 is a flow chart showing an example of game processing regarding the racing game. The game processing is started if an instruction to start the racing game is given by the player. In FIG. 13, a process regarding the above vibration control of the left vibrator 36 and the right vibrator 46 based on the vibration sources is mainly described, and other processes are described in a simplified manner.

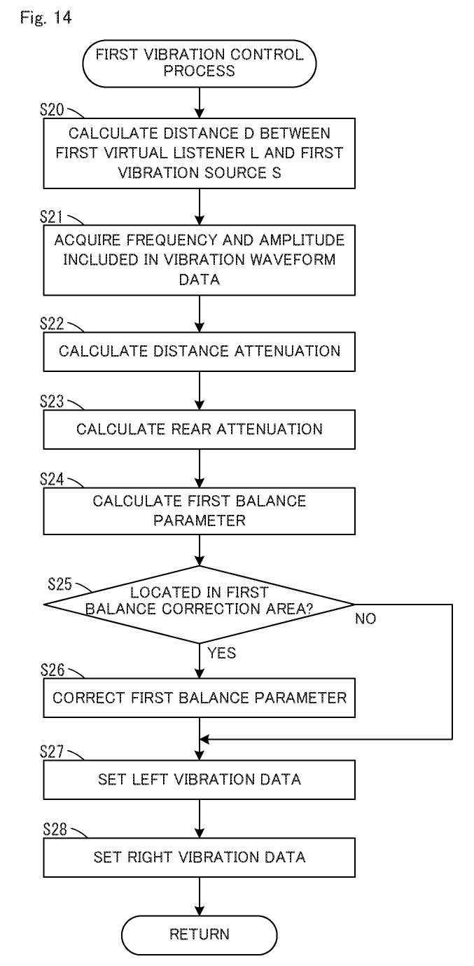

In the exemplary embodiment, the description is given on the assumption that the processes of steps shown in FIGS. 13 and 14 are executed by the processor 21 of the main body apparatus 2 executing the game program using a memory. In another exemplary embodiment, however, some of the processes of the steps may be executed by a processor (e.g., a dedicated circuit or the like) different from the processor 21. In a case where the game system 1 can communicate with another information processing apparatus, some of the processes of the steps may be executed by another information processing apparatus. The processes of all of the steps are merely illustrative. Thus, the processing order of the steps may be changed, or another process may be performed in addition to (or instead of) the processes of all of the steps, so long as similar results are obtained.

As shown in FIG. 13, first, the processor 21 performs an initial process (step S11). Here, the processor 21 sets any one of a plurality of courses based on a selection operation of the player and starts the racing game. In the initial process, the player object P, the virtual camera VC, the first virtual listener L, the second virtual listener M, the first vibration source S, and the second vibration source T are set in the virtual space. The number and the types of vibration sources to be set differ depending on the course. Here, at least one first vibration source S and at least one second vibration source T are set in the virtual space.

If the racing game is started, the processor 21 acquires operation data from the controllers 3 and 4 (step S12). From this point onward, the processor 21 repeatedly executes the processes of steps S12 to S18 at predetermined frame time intervals (e.g., 1/60-second intervals). While the processes of steps S12 to S18 are repeatedly executed at predetermined frame time intervals, communication between the main body apparatus 2 and the controllers 3 and 4 is repeatedly performed at predetermined time intervals (e.g., 1/200-second intervals). Through the communication between the main body apparatus 2 and the controllers 3 and 4, vibration data is transmitted from the main body apparatus 2 to the controllers 3 and 4. FIG. 13 omits the communication between the main body apparatus 2 and the controllers 3 and 4.

Next, the processor 21 executes a player object control process (step S13). Here, based on the operation data, the processor 21 updates the position, the direction, the velocity, the moving direction, and the like of the player object P. For example, the processor 21 updates the velocity, the direction, and the moving direction of the player object P based on operation data and updates the position of the player object P based on the updated velocity, direction, and moving direction. The processor 21 also updates the position of the virtual camera VC. For example, the processor 21 sets the virtual camera VC at a position a certain distance away from the player object P so that the player object P is located in the direction of the line of sight CD of the virtual camera VC. The processor 21 also updates the position LP of the first virtual listener L. Specifically, the processor 21 sets the first virtual listener L at the position of the virtual camera VC. The processor 21 also updates the position MP of the second virtual listener M. Specifically, the processor 21 sets the second virtual listener M at the position of the player object P.

Next, the processor 21 performs an other object control process (step S14). Here, the processor 21 controls objects present in the virtual space other than the player object P. For example, the processor 21 updates the position, the direction, the velocity, the moving direction, and the like of an opponent object as an opponent of the player object P. For example, if the racing game is being performed by a plurality of players, based on game data received from another main body apparatus 2, the processor 21 controls an opponent object (a player object of the other main body apparatus 2). If the racing game is being performed by a single player, the processor 21 controls an opponent object based on a predetermined algorithm. If the first vibration source S is an object that moves in the virtual space, the processor 21 moves the first vibration source S in the virtual space. If the second vibration source T is an object that moves in the virtual space, the processor 21 moves the second vibration source T in the virtual space.

Next, the processor 21 performs a first vibration control process (step S15). Here, the process of calculating a vibration regarding the first vibration source S set in the virtual space is performed. The details of the first vibration control process in step S15 are described below. FIG. 14 is a flow chart showing the details of the first vibration control process in step S15.

### First Vibration Control Process

As shown in FIG. 14, the processor 21 calculates the distance d between the first virtual listener L and the first vibration source S (step S20). Only if the distance d between the first virtual listener L and the first vibration source S is less than a predetermined threshold, the processor 21 may execute the processes of the next steps S21 to S28. If the distance d is greater than or equal to the predetermined threshold, the processor 21 may end the process shown in FIG. 14 without executing the processes of steps S21 to S28.

Next, the processor 21 acquires the frequency and the amplitude included in the vibration waveform data corresponding to the first vibration source S stored in advance (step S21). Specifically, in accordance with the elapsed time from the start of the reproduction of the vibration waveform data corresponding to the first vibration source S, the processor 21 acquires the frequency and the amplitude in the high-frequency band and the frequency and the amplitude in the low-frequency band included in the vibration waveform data.

Next, the processor 21 calculates the distance attenuation based on the distance d calculated in step S20 (step S22). Specifically, the processor 21 calculates the entire attenuation rate based on the distance d using the entire attenuation curve shown in FIG. 5. Next, the processor 21 performs the entire attenuation by multiplying the amplitudes in the high-frequency band and the low-frequency band acquired in step S21 by the entire attenuation rate. Further, the processor 21 calculates the high-frequency band attenuation rate based on the distance d using the high-frequency band attenuation curve shown in FIG. 6. Then, the processor 21 performs the high-frequency band attenuation by multiplying the amplitude in the high-frequency band after the entire attenuation by the high-frequency band attenuation rate.

Next, the processor 21 calculates the rear attenuation based on the distance d calculated in step S20 (step S23). Specifically, the processor 21 calculates the angle θ between the front direction (the direction of the line of sight CD) of the virtual camera VC and the direction from the first virtual listener L to the first vibration source S. Next, the processor 21 calculates the rear rate by dividing the angle θby 180 degrees and calculates "the rear attenuation rate of the amplitude" using the amplitude rear attenuation curve shown in FIG. 8. Then, the processor 21 multiplies the amplitudes in the high-frequency band and the low-frequency band calculated by the distance attenuation in step S22 by "the rear attenuation rate of the amplitude". If the amplitude is not attenuated by the distance attenuation in step S22, the processor 21 multiplies the amplitudes in the high-frequency band and the low-frequency band acquired in step S21 by "the rear attenuation rate of the amplitude". The processor 21 also calculates "the rear attenuation rate of the frequency" using the frequency rear attenuation curve shown in FIG. 9. Then, the processor 21 decreases the frequencies in the high-frequency band and the low-frequency band by multiplying the frequencies in the high-frequency band and the low-frequency band acquired from the vibration waveform data in step S21 by "the rear attenuation rate of the frequency". Consequently, regarding both the high-frequency band and the low-frequency band, the amplitudes become small and the frequencies also decreases in accordance with the rear rate. Instead of decreasing the frequencies themselves in the high-frequency band and the low-frequency band, the amplitude in only the high-frequency band between the high-frequency band and the low-frequency band may be decreased.

Next, the processor 21 calculates the first balance parameter based on the positional relationship between the first virtual listener L and the first vibration source S (step S24). For example, the processor 21 calculates the first balance parameter based on the angle θcalculated in step S23. The first balance parameter is a parameter indicating the bias degree of the intensities of the vibrations of the left vibrator 36 and the right vibrator 46. For example, if the angle θ is "0 degrees", the value of the first balance parameter is set to the "value indicating that the intensities of the vibrations of the left vibrator 36 and the right vibrator 46 are not biased". For example, if the first vibration source S is to the left side of the first virtual listener L and the above angle θis "90 degrees", the value of the first balance parameter is set to a "value indicating that only the left vibrator 36 is vibrated".

Next, the processor 21 determines whether or not the first vibration source S is located in the first balance correction area having the radius r1 centered at the first virtual listener L (step S25).

If the first vibration source S is located in the first balance correction area (step S25: YES), the processor 21 corrects the first balance parameter calculated in step S24 (step S26). Specifically, in accordance with the value of the distance d/r1, the processor 21 makes correction to bring the first balance parameter close to the "value indicating that the intensities of the vibrations of the left vibrator 36 and the right vibrator 46 are not biased". For example, if the first balance parameter calculated in step S24 is a value indicating that the left vibrator 36 and the right vibrator 46 are vibrated at a ratio of "10:0", the processor 21 corrects the first balance parameter to a value indicating that the left vibrator 36 and the right vibrator 46 are vibrated at a ratio of "8:2".

If the process of step S26 is performed, or if the determination is NO in step S25, the processor 21 sets the left vibration data (step S27). Here, the processor 21 sets the amplitudes in the high-frequency band and the low-frequency band of the left vibrator 36 based on the amplitudes decreased in the above steps S22 and S23 and the first balance parameter calculated in step S24 or S26. The processor 21 also sets the frequencies in the high-frequency band and the low-frequency band decreased in step S23. Then, the processor 21 sets the left vibration data including the first vibration data indicating the frequency and the amplitude in the high-frequency band and the second vibration data indicating the frequency and the amplitude in the low-frequency band in a memory.

Next, the processor 21 sets the right vibration data (step S28). Here, the processor 21 sets the amplitudes in the high-frequency band and the low-frequency band of the right vibrator 46 based on the amplitudes decreased in the above steps S22 and S23 and the first balance parameter calculated in step S24 or S26. The processor 21 also sets the frequencies in the high-frequency band and the low-frequency band decreased in step S23. Then, the processor 21 sets the right vibration data including the first vibration data indicating the frequency and the amplitude in the high-frequency band and the second vibration data indicating the frequency and the amplitude in the low-frequency band in the memory.

The set left vibration data and right vibration data are transmitted to the left controller 3 and the right controller 4 through the communication between the main body apparatus 2 and the left controller 3 and the right controller 4 performed at the predetermined time intervals (e.g., 1/200-second intervals). The left controller 3 vibrates the left vibrator 36 based on the received left vibration data. The same applies to the right controller 4.

If the process of step S28 is performed, the processor 21 ends the process shown in FIG. 14, and the processing returns to FIG. 13.

Referring back to FIG. 13, after the process of step S15, next, the processor 21 performs a second vibration control process (step S16). The second vibration control process is the process of controlling vibrations based on the second vibration source T. In the second vibration control process, the above distance attenuation is calculated based on the distance d between the second virtual listener M and the second vibration source T. In the second vibration control process, the above rear attenuation is not calculated. In the second vibration control process, it is determined whether or not the second vibration source T is located in the second balance correction area having the radius r2 centered at the second virtual listener M (the player object P). The radius r2 may be set to be slightly smaller than the player object P. In the second vibration control process, the above rear attenuation may also be calculated. The second vibration control process is a process similar to the first vibration control process, and therefore is not described in detail.

Next, the processor 21 performs a drawing process (step S17). In the drawing process, a game image of the virtual space viewed from the virtual camera VC is generated, and the generated game image is displayed on a display device.

Next, the processor 21 determines whether or not to end the game (step S18). For example, based on whether or not the player object P reaches a goal, the processor 21 determines whether or not to end the game. If the determination is YES in step S18, the processor 21 ends the processing shown in FIG. 13. If the determination is NO in step S18, the processor 21 executes the process of step S12 again.

As described above, in the exemplary embodiment, regarding a vibration based on the first vibration source S, the first virtual listener L is set at the position of the virtual camera VC, and the distance attenuation is performed based on the distance between the first vibration source S and the first virtual listener L. If the first vibration source S is located posterior to the virtual camera VC, the rear attenuation is performed in addition to the distance attenuation (step S23). Consequently, it is possible to cause the player to feel the vibration based on the first vibration source S located anterior to the player more and cause the player to focus on the first vibration source S located anterior to the player.

In the exemplary embodiment, the first balance correction area BCL having a relatively great radius r1 is set at the position of the first virtual listener L, and if the first vibration source S is located in the first balance correction area BCL, correction is made so that the bias of the vibrations of the left vibrator 36 and the right vibrator 46 is small. Consequently, regarding a vibration source close to the first virtual listener L, it is possible to cause the player to feel a vibration from the vibration source more and generate a vibration by focusing more on the closeness to the vibration source than on the direction of the vibration source.

In the exemplary embodiment, regarding a vibration based on the second vibration source T, the second virtual listener M is set at the position of the player object P, and the second balance correction area BCM having the radius r2 is set at the position of the second virtual listener M. The second balance correction area BCM is set to have almost the same size as that of the player object P. If the second vibration source T is located in the second balance correction area, correction is made so that the bias of the vibrations of the left vibrator 36 and the right vibrator 46 is small. Thus, for example, if the player object P overlaps the second vibration source T, it is possible to make the bias of the vibrations of the left vibrator 36 and the right vibrator 46 small, and it is possible to vibrate the left and right vibrators by great amounts.

### Variations

While the exemplary embodiment has been described above, the exemplary embodiment is merely an example and may be modified as follows, for example.

For example, in the above exemplary embodiment, the greater the distance between a vibration source and a virtual listener is, the more attenuated the amplitudes in the high-frequency band and the low-frequency band are, and the even more attenuated the amplitude in the high-frequency band is. In another exemplary embodiment, for example, the amplitude in the high-frequency band may be attenuated using a low-pass filter. The low-pass filter may attenuate the amplitude of vibration data greater than or equal to a predetermined frequency.

Although in the above exemplary embodiment, the first virtual listener L is set at the position of the virtual camera VC, the first virtual listener L may not necessarily be set at a position coinciding with the virtual camera so long as the first virtual listener L is set at a position corresponding to the position of the virtual camera VC. Although in the above exemplary embodiment, the second virtual listener M is set at the position of the player object P, the second virtual listener M may not necessarily be set at a position coinciding with the player object P so long as the second virtual listener M is set at a position corresponding to the position of the player object P.

In the above exemplary embodiment, based on the curves shown in FIGS. 5, 6, 8 and 9, the attenuation rates are calculated. In another exemplary embodiment, the attenuation rates may be calculated based on formulas.

In the above exemplary embodiment, the amplitudes are attenuated by the distance attenuation, and the amplitudes and the frequencies are attenuated by the rear attenuation. In another exemplary embodiment, the frequencies may be decreased in addition to the amplitudes by the distance attenuation. In another exemplary embodiment, only the amplitudes may be attenuated by the rear attenuation.

In the above exemplary embodiment, the amplitudes and the frequencies in both the high-frequency band and the low-frequency band are decreased by the rear attenuation. In another exemplary embodiment, the amplitude and/or the frequency in either one of the high-frequency band and the low-frequency band may be decreased by the rear attenuation.

In the above exemplary embodiment, the first virtual listener L and the second virtual listener M are separately set, the first virtual listener L is set at the position of the virtual camera, and the second virtual listener M is set at the position of the player object P. In another exemplary embodiment, only a single virtual listener may be provided, and the virtual listener may be set at the position of the virtual camera or the player object P.

In the above exemplary embodiment, regarding the first vibration source S and the second vibration source T, the distance attenuation based on the distance and the rear attenuation based on the rear rate are performed. In another exemplary embodiment, regarding the first vibration source S and/or the second vibration source T, only the distance attenuation may be performed, and the rear attenuation may not be performed.

In the above exemplary embodiment, on the premise that a racing game is performed where a player object P moves in a virtual space, vibration control for causing a player to feel a vibration from a vibration source placed in the virtual space is performed. In another exemplary embodiment, the above vibration control may be performed not only in a racing game, but also in any game. For example, the above vibration control may be performed in a game where a vibration source and a player object freely move in a virtual space, a shooting game, a role-playing game, a fighting game, or the like. The above vibration control may be used not only in a game, but also to cause a user to feel any virtual vibration source set in a virtual space.

The above vibration control process may be executed not only by the game system 1, but also by any other information processing apparatus or information processing system. For example, the information processing apparatus may be a smartphone, a tablet terminal, a personal computer, a game apparatus, a server, or the like. The information processing system may be formed of a plurality of apparatuses, and the plurality of apparatuses may be connected together via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to perform operations comprising:
regarding first vibration waveform data associated with a first virtual vibration source set in a virtual space and used to vibrate a vibration device,
attenuating an amplitude of the first vibration waveform data so that the greater a distance between a first virtual listener and the first virtual vibration source in the virtual space is, the more attenuated the amplitude is, and so that the further away from a front direction of a virtual camera in the virtual space a direction of the first virtual vibration source relative to the first virtual listener is, the even more attenuated the amplitude is, and
outputting the first vibration waveform data based on the attenuated amplitude.

2. The one or more non-transitory computer-readable storage media according to claim 1, wherein
the first virtual listener is set at a position corresponding to a position of the virtual camera.

3. The one or more non-transitory computer-readable storage media according to claim 1, wherein
the operations further comprise
decreasing a pitch of the first vibration waveform data so that the further away from the front direction of the virtual camera in the virtual space the direction of the first virtual vibration source relative to the first virtual listener is, the more decreased the pitch is.

4. The one or more non-transitory computer-readable storage media according to claim 1, wherein
the operations further comprise
attenuating an amplitude of a high-frequency component of the first vibration waveform data so that the greater the distance between the first virtual listener and the first virtual vibration source in the virtual space is, the more attenuated the amplitude is, and so that the further away from the front direction of the virtual camera in the virtual space the direction of the first virtual vibration source relative to the first virtual listener is, the more attenuated the amplitude is.

5. The one or more non-transitory computer-readable storage media according to claim 2, wherein
the operations further comprise:
controlling a player object in the virtual space based on an operation input; and
regarding second vibration waveform data associated with a second virtual vibration source set in the virtual space and used to vibrate the vibration device,
attenuating an amplitude of the second vibration waveform data so that the greater a distance between a second virtual listener set at a position corresponding to the player object and the second virtual vibration source is, the more attenuated the amplitude is, and
outputting the second vibration waveform data based on the attenuated amplitude.

6. The one or more non-transitory computer-readable storage media according to claim 1, wherein
the vibration device at least includes a first vibration device and a second vibration device, and
the operations further comprise:
if the distance between the first virtual listener and the first virtual vibration source is further closer than a first reference, making correction to bring a first left/right balance parameter close to a value indicating that a left/right bias is small, the first left/right balance parameter indicating a left/right bias degree according to a slope with respect to the front direction of the virtual camera in the direction of the first virtual vibration source relative to the first virtual listener; and
based on the first left/right balance parameter, determining the amplitude of the first vibration waveform data for the first vibration device and the amplitude of the first vibration waveform data for the second vibration device and outputting the amplitudes.

7. The one or more non-transitory computer-readable storage media according to claim 6, wherein
the operations further comprise:
controlling a player object in the virtual space based on an operation input; and
regarding second vibration waveform data associated with a second virtual vibration source set in the virtual space and used to vibrate the vibration device,
if a distance between a second virtual listener set at a position corresponding to the player object and a second virtual vibration source is further closer than a second reference, making correction to bring a second left/right balance parameter close to a value indicating that the left/right bias is small, the second left/right balance parameter indicating a left/right bias degree according to a slope with respect to the front direction of the virtual camera in a direction of the second virtual vibration source relative to the second virtual listener, and
based on the second left/right balance parameter, determining the amplitude of the first vibration waveform data for the first vibration device and the amplitude of the second vibration waveform data for the second vibration device and outputting the amplitudes.

8. One or more non-transitory computer-readable storage media having stored therein instructions that, when executed, cause one or more processors to perform operations comprising:
controlling a player object in a virtual space based on an operation input;
controlling a virtual camera in the virtual space; and
regarding first vibration waveform data associated with a first virtual vibration source set in the virtual space and second vibration waveform data associated with a second virtual vibration source set in the virtual space that are used to vibrate a vibration device including a first vibration device and a second vibration device,
attenuating an amplitude of the first vibration waveform data so that the greater a distance between a first virtual listener set at a position corresponding to a position of the virtual camera and the first virtual vibration source is, the more attenuated the amplitude is,
if the distance between the first virtual listener and the first virtual vibration source is further closer than a first reference, making correction to bring a first left/right balance parameter close to a value indicating that a left/right bias is small, the first left/right balance parameter indicating a left/right bias degree according to a slope with respect to a front direction of the virtual camera in a direction of the first virtual vibration source relative to the first virtual listener,
based on the first left/right balance parameter, determining the amplitude of the first vibration waveform data for the first vibration device and the amplitude of the first vibration waveform data for the second vibration device and outputting the amplitudes,
attenuating an amplitude of the second vibration waveform data so that the greater a distance between a second virtual listener set at a position corresponding to the player object and the second virtual vibration source is, the more attenuated the amplitude is,
if the distance between the second virtual listener and the second virtual vibration source is further closer than a second reference, making correction to bring a second left/right balance parameter close to a value indicating that a left/right bias is small, the second left/right balance parameter indicating a left/right bias degree according to a slope with respect to the front direction of the virtual camera in the a direction of the second virtual vibration source relative to the second virtual listener, and
based on the second left/right balance parameter, determining the amplitude of the first vibration waveform data for the first vibration device and the amplitude of the second vibration waveform data for the second vibration device and outputting the amplitudes.

9. A computer-implemented method comprising:
regarding first vibration waveform data associated with a first virtual vibration source set in a virtual space and used to vibrate a vibration device,
attenuating an amplitude of the first vibration waveform data so that the greater a distance between a first virtual listener and the first virtual vibration source in the virtual space is, the more attenuated the amplitude is, and so that the further away from a front direction of a virtual camera in the virtual space a direction of the first virtual vibration source relative to the first virtual listener is, the even more attenuated the amplitude is, and
outputting the first vibration waveform data based on the attenuated amplitude.

10. The computer-implemented method according to claim 9, wherein
the first virtual listener is set at a position corresponding to a position of the virtual camera.

11. The computer-implemented method according to claim 9, further comprising decreasing a pitch of the first vibration waveform data so that the further away from the front direction of the virtual camera in the virtual space the direction of the first virtual vibration source relative to the first virtual listener is, the more decreased the pitch is.

12. The computer-implemented method according to claim 9, further comprising attenuating an amplitude of a high-frequency component of the first vibration waveform data so that the greater the distance between the first virtual listener and the first virtual vibration source in the virtual space is, the more attenuated the amplitude is, and so that the further away from the front direction of the virtual camera in the virtual space the direction of the first virtual vibration source relative to the first virtual listener is, the more attenuated the amplitude is.

13. The computer-implemented method according to claim 10, further comprising:
controlling a player object in the virtual space based on an operation input; and
regarding second vibration waveform data associated with a second virtual vibration source set in the virtual space and used to vibrate the vibration device,
attenuating an amplitude of the second vibration waveform data so that the greater a distance between a second virtual listener set at a position corresponding to the player object and the second virtual vibration source is, the more attenuated the amplitude is, and
outputting the second vibration waveform data based on the attenuated amplitude.

14. The computer-implemented method according to claim 9, wherein
the vibration device at least includes a first vibration device and a second vibration device, and
the computer-implemented method further comprises:
if the distance between the first virtual listener and the first virtual vibration source is further closer than a first reference, making correction to bring a first left/right balance parameter close to a value indicating that a left/right bias is small, the first left/right balance parameter indicating a left/right bias degree according to a slope with respect to the front direction of the virtual camera in the direction of the first virtual vibration source relative to the first virtual listener; and
based on the first left/right balance parameter, determining the amplitude of the first vibration waveform data for the first vibration device and the amplitude of the first vibration waveform data for the second vibration device and outputting the amplitudes.

15. The computer-implemented method according to claim 14, further comprising:
controlling a player object in the virtual space based on an operation input; and
regarding second vibration waveform data associated with a second virtual vibration source set in the virtual space and used to vibrate the vibration device,
if a distance between a second virtual listener set at a position corresponding to the player object and a second virtual vibration source is further closer than a second reference, making correction to bring a second left/right balance parameter close to a value indicating that the left/right bias is small, the second left/right balance parameter indicating a left/right bias degree according to a slope with respect to the front direction of the virtual camera in a direction of the second virtual vibration source relative to the second virtual listener, and
based on the second left/right balance parameter, determining the amplitude of the first vibration waveform data for the first vibration device and the amplitude of the second vibration waveform data for the second vibration device and outputting the amplitudes.

16. A computer-implemented method comprising:
controlling a player object in a virtual space based on an operation input;
controlling a virtual camera in the virtual space; and
regarding first vibration waveform data associated with a first virtual vibration source set in the virtual space and second vibration waveform data associated with a second virtual vibration source set in the virtual space that are used to vibrate a vibration device including a first vibration device and a second vibration device,
attenuating an amplitude of the first vibration waveform data so that the greater a distance between a first virtual listener set at a position corresponding to a position of the virtual camera and the first virtual vibration source is, the more attenuated the amplitude is,
if the distance between the first virtual listener and the first virtual vibration source is further closer than a first reference, making correction to bring a first left/right balance parameter close to a value indicating that a left/right bias is small, the first left/right balance parameter indicating a left/right bias degree according to a slope with respect to a front direction of the virtual camera in a direction of the first virtual vibration source relative to the first virtual listener,
based on the first left/right balance parameter, determining the amplitude of the first vibration waveform data for the first vibration device and the amplitude of the first vibration waveform data for the second vibration device and outputting the amplitudes,
attenuating an amplitude of the second vibration waveform data so that the greater a distance between a second virtual listener set at a position corresponding to the player object and the second virtual vibration source is, the more attenuated the amplitude is,
if the distance between the second virtual listener and the second virtual vibration source is further closer than a second reference, making correction to bring a second left/right balance parameter close to a value indicating that a left/right bias is small, the second left/right balance parameter indicating a left/right bias degree according to a slope with respect to the front direction of the virtual camera in the a direction of the second virtual vibration source relative to the second virtual listener, and
based on the second left/right balance parameter, determining the amplitude of the first vibration waveform data for the first vibration device and the amplitude of the second vibration waveform data for the second vibration device and outputting the amplitudes.

17. An information processing system comprising:
one or more processors; and
one or more non-transitory computer-readable media storing instructions that, when executed, cause the one or more processors to perform operations comprising:
regarding first vibration waveform data associated with a first virtual vibration source set in a virtual space and used to vibrate a vibration device,
attenuating an amplitude of the first vibration waveform data so that the greater a distance between a first virtual listener and the first virtual vibration source in the virtual space is, the more attenuated the amplitude is, and so that the further away from a front direction of a virtual camera in the virtual space a direction of the first virtual vibration source relative to the first virtual listener is, the even more attenuated the amplitude is, and
outputting the first vibration waveform data based on the attenuated amplitude.

18. The information processing system according to claim 17, wherein
the first virtual listener is set at a position corresponding to a position of the virtual camera.

19. The information processing system according to claim 17, wherein
the operations further comprise decreasing a pitch of the first vibration waveform data so that the further away from the front direction of the virtual camera in the virtual space the direction of the first virtual vibration source relative to the first virtual listener is, the more decreased the pitch is.

20. The information processing system according to claim 17, wherein
the operations further comprise attenuating an amplitude of a high-frequency component of the first vibration waveform data so that the greater the distance between the first virtual listener and the first virtual vibration source in the virtual space is, the more attenuated the amplitude is, and so that the further away from the front direction of the virtual camera in the virtual space the direction of the first virtual vibration source relative to the first virtual listener is, the more attenuated the amplitude is.

21. The information processing system according to claim 18, wherein
the operations further comprise:
controlling a player object in the virtual space based on an operation input; and
regarding second vibration waveform data associated with a second virtual vibration source set in the virtual space and used to vibrate the vibration device,
attenuating an amplitude of the second vibration waveform data so that the greater a distance between a second virtual listener set at a position corresponding to the player object and the second virtual vibration source is, the more attenuated the amplitude is, and
outputting the second vibration waveform data based on the attenuated amplitude.

22. The information processing system according to claim 17, wherein
the vibration device at least includes a first vibration device and a second vibration device, and
the operations further comprise:
if the distance between the first virtual listener and the first virtual vibration source is further closer than a first reference with respect to a first left/right balance parameter indicating a left/right bias degree according to a slope with respect to the front direction of the virtual camera in the direction of the first virtual vibration source relative to the first virtual listener, making correction to bring the first left/right balance parameter close to a value indicating that a left/right bias is small; and
based on the first left/right balance parameter, determining the amplitude of the first vibration waveform data for the first vibration device and the amplitude of the first vibration waveform data for the second vibration device and outputting the amplitudes.

23. The information processing system according to claim 22, wherein
the operations further comprise:
controlling a player object in the virtual space based on an operation input; and
regarding second vibration waveform data associated with a second virtual vibration source set in the virtual space and used to vibrate the vibration device,
if a distance between a second virtual listener set at a position corresponding to the player object and a second virtual vibration source is further closer than a second reference, making correction to bring a second left/right balance parameter close to a value indicating that the left/right bias is small, the second left/right balance parameter indicating a left/right bias degree according to a slope with respect to the front direction of the virtual camera in a direction of the second virtual vibration source relative to the second virtual listener, and
based on the second left/right balance parameter, determining the amplitude of the first vibration waveform data for the first vibration device and the amplitude of the second vibration waveform data for the second vibration device and outputting the amplitudes.
